(19) United States
(12) Patent Application Publication
(10) Pub. No.: US 2019/0275944 A1
(43) Pub. Date: Sep. 12, 2019

(54) VIEWING DEVICE FOR VEHICLE

(71) Applicant: KABUSHIKI KAISHA TOKAI-RIKA-DENKI-SEISAKUSHO, Aichi (JP)

(72) Inventors: Suguru FUJISAKI, Aichi (JP); Shigeki YOSHIDA, Aichi (JP)

(21) Appl. No.: 16/333,002

(22) PCT Filed: Aug. 30, 2017
(86) PCT No.: PCT/JP2017/031253

§ 371 Date: Mar. 13, 2019

(30) Foreign Application Priority Data
Sep. 20, 2016 (JP) 2016-183428

(51) Int. Cl. B60R 1/072

(52) U.S. Cl. CPC B60R 1/072

(57) ABSTRACT

In a door mirror device for a vehicle, a visor body covers a vehicle rear side of a motor of a mirror surface adjusting mechanism, and a reinforcement is disposed at a vehicle front side of the motor, and the reinforcement reinforces the visor body. Here, holding ribs of the reinforcement stop rotation of a main body portion of the motor around an output shaft. Therefore, the main body portion being rotated around the output shaft by reaction force that arises due to the motor being driven can be suppressed.

### Technical Field

The present invention relates to a viewing device for a vehicle at which a viewing mechanism assists viewing by an occupant of a vehicle.

### Background Art

In the electric door mirror disclosed in Japanese Patent Application Laid-Open (JP-A) No. 2013-67194, at a mirror surface angle adjusting unit, a motor is driven, the output shaft of the motor is rotated, and a mirror is thereby tilted. Further, an inner member covers the mirror side of the motor, and a motor holder is disposed at the side, which is opposite from the mirror, of the motor, and the motor holder reinforces the inner member.

Here, at such an electric door mirror, it is preferable to be able to suppress the main body portion of the motor being rotated around the output shaft by the reaction force that arises due to the motor being driven.

### SUMMARY OF INVENTION

### Technical Problem

In view of the above-described circumstances, an object of the present invention is to provide a viewing device for a vehicle that can suppress a main body portion being rotated around an output shaft by the reaction force that arises due to the motor being driven.

### Solution to Problem

A viewing device for a vehicle of a first aspect of the present invention, the viewing device comprises: a viewing mechanism that assists viewing by an occupant of the vehicle; a tilting mechanism at which a motor, having an output shaft extending out from a main body portion, is provided, the viewing mechanism being tilted due to the motor being driven and the output shaft being rotated; a covering body that covers a viewing mechanism side of the motor; a reinforcing body that is disposed at a side, which is opposite from the viewing mechanism, of the motor, and that reinforces the covering body; and a stopping portion that is provided so as to project out from the reinforcing body, and that stops rotation of the main body portion around the output shaft.

In a viewing device for a vehicle of a second aspect of the present invention, in the viewing device for a vehicle of the first aspect of the present invention, the stopping portion is extended along the output shaft.

In a viewing device for a vehicle of a third aspect of the present invention, in the viewing device for a vehicle of the first aspect or the second aspect of the present invention, the stopping portion is provided at a plurality of positions around the output shaft.

In a viewing device for a vehicle of a fourth aspect of the present invention, the viewing device for a vehicle of any one of the first aspect through the third aspect of the present invention comprises a terminal that is provided integrally with the reinforcing body, that is inserted into the main body portion, and that supplies electric power.

### Advantageous Effects of Invention

In the viewing device for a vehicle of the first aspect of the present invention, the viewing mechanism assists viewing by an occupant of the vehicle. Moreover, at the motor of the tilting mechanism, the output shaft extends out from the main body portion. At the tilting mechanism, the motor is driven and the output shaft is rotated, and, due thereto, the viewing mechanism is tilted. Further, the covering body covers the viewing mechanism side of the motor, and the reinforcing body is disposed at the side, which is opposite from the viewing mechanism, of the motor, and the reinforcing body reinforces the covering body.

Here, the stopping portion is provided so as to project out at the reinforcing body. The stopping portion stops rotation of the main body portion around the output shaft. Therefore, the main body portion being rotated around the output shaft by the reaction force that arises due to the motor being driven can be suppressed.

In the viewing device for a vehicle of the second aspect of the present invention, the stopping portion is extended along the output shaft. Therefore, the stopping portion can effectively stop rotation of the main body portion around the output shaft, and the main body portion being rotated around the output shaft by the reaction force that arises due to the motor being driven can be suppressed effectively.

In the viewing device for a vehicle of the third aspect of the present invention, the stopping portion is provided at plural positions around the output shaft. Therefore, the plural stopping portions can effectively stop rotation of the main body portion around the output shaft, and the main body portion being rotated around the output shaft by the reaction force that arises due to the motor being driven can be suppressed effectively.

In the viewing device for a vehicle of the fourth aspect of the present invention, the terminal is provided integrally with the reinforcing body, and the terminal is inserted into the main body portion and supplies electric power. Therefore, the terminal can stop rotation of the main body portion around the output shaft, and the main body portion being rotated around the output shaft by the reaction force that arises due to the motor being driven can be suppressed effectively.

### BRIEF DESCRIPTION OF DRAWINGS

FIG. 1 is an exploded perspective view that is seen from a vehicle front side and a vehicle transverse direction inner side and shows a door mirror device for a vehicle relating to an embodiment of the present invention.

FIG. 2 is a cross-sectional view that is seen from a vehicle transverse direction outer side and shows main portions of the door mirror device for a vehicle relating to the embodiment of the present invention.

FIG. 3 is a perspective view that is seen from a vehicle rear side and the vehicle transverse direction inner side and shows a visor body of the door mirror device for a vehicle relating to the embodiment of the present invention.

FIG. 4 is an exploded perspective view that is seen from the vehicle front side and a lower side and shows the visor body and a reinforcement and the like of the door mirror device for a vehicle relating to the embodiment of the present invention.

FIG. 5 is a front view that is seen from the vehicle front side and shows the visor body and the reinforcement and the like of the door mirror device for a vehicle relating to the embodiment of the present invention.

FIG. 6 is a cross-sectional view (a cross-sectional view along line 6-6 of FIG. 5) showing the visor body and the reinforcement and the like of the door mirror device for a vehicle relating to the embodiment of the present invention.

### DESCRIPTION OF EMBODIMENTS

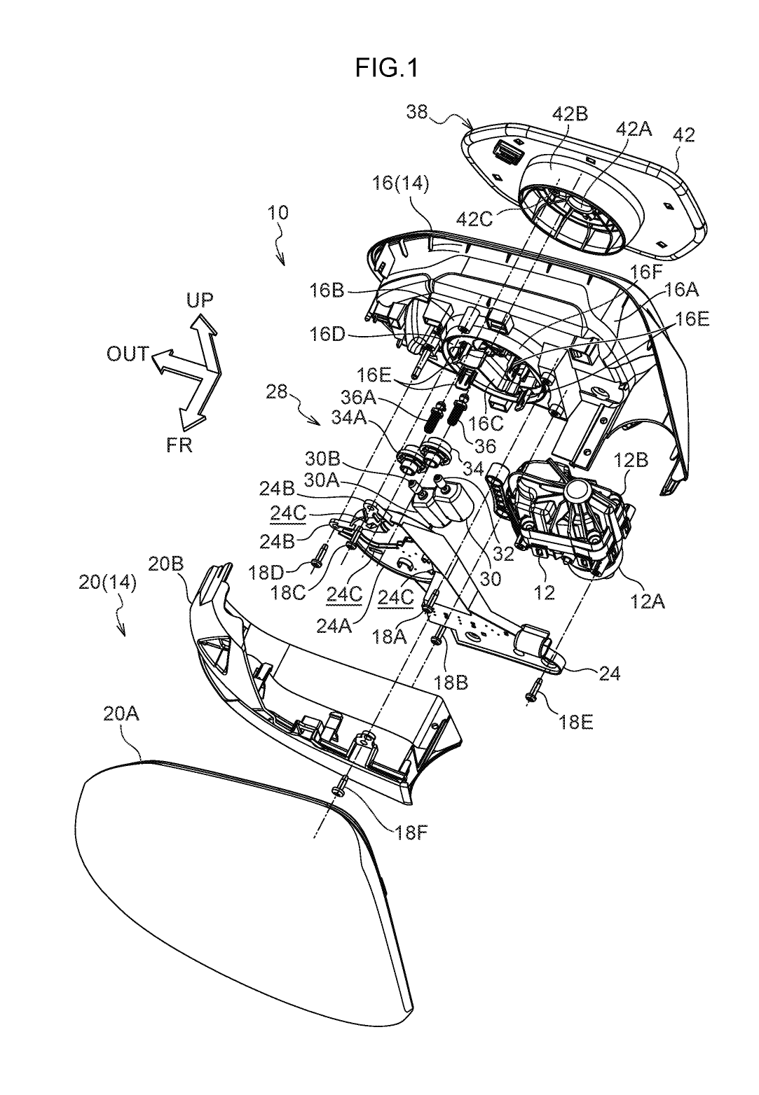

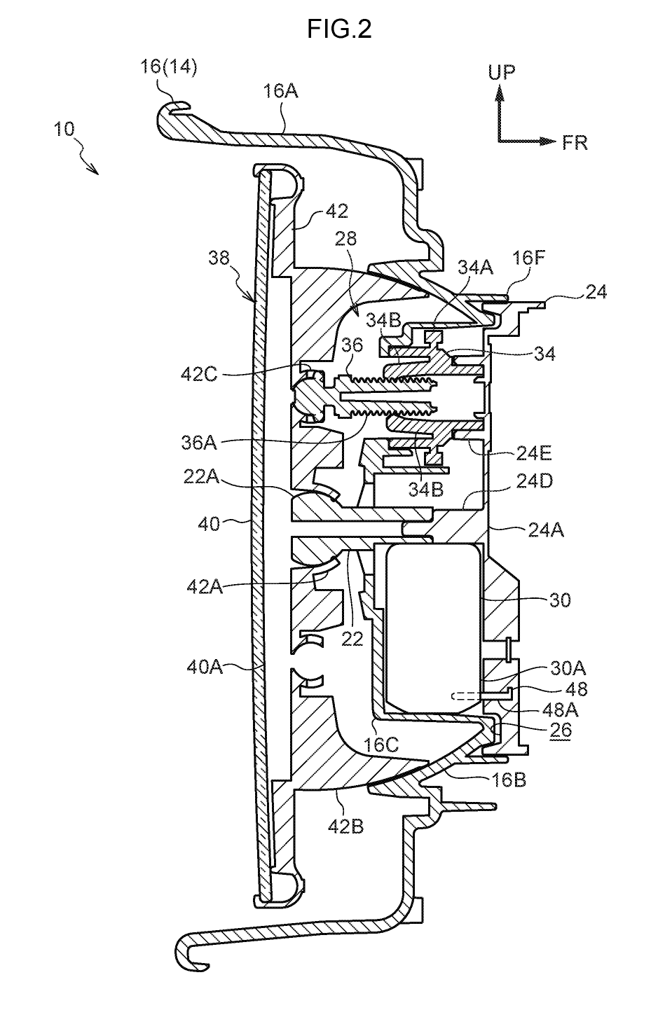

A door mirror device 10 for a vehicle, which serves as a viewing device for a vehicle and relates to an embodiment of the present invention, is shown in FIG. 1 in an exploded perspective view seen from a vehicle front side and a vehicle transverse direction inner side (the vehicle left side). Main portions of the door mirror device 10 for a vehicle are shown in FIG. 2 in a cross-sectional view that is seen from a vehicle transverse direction outer side (the vehicle right side). Note that, in the drawings, the vehicle forward side is indicated by arrow FR, the vehicle transverse direction outer side is indicated by arrow OUT, and the upper side is indicated by arrow UP.

The door mirror device 10 for a vehicle relating to the present embodiment is supported at the outer side of a door (a front side door, the vehicle body side) of a vehicle.

As shown in FIG. 1, the door mirror device 10 for a vehicle has a retracting mechanism 12. A stand 12A that serves as a supporting member is provided at the retracting mechanism 12. The door mirror device 10 for a vehicle is supported at the door due to the stand 12A being supported at the vehicle front side end of the vertical direction intermediate portion of the door. A rotating body 12B is supported at the stand 12A. Due to the retracting mechanism 12 being operated electrically, the rotating body 12B is rotated around the vertical direction with respect to the stand 12A. The rotating body 12B is electrically connected to a control device (not illustrated) at the vehicle body side, and the retracting mechanism 12 is electrically operated by control of the control device.

A visor 14, which is made of resin and serves as an outer peripheral body, is supported at the rotating body 12B of the retracting mechanism 12. A visor body 16 that serves as a covering body is provided at the visor 14. The rotating body 12B is fixed to the vehicle front side of the vehicle transverse direction inner side end portion of the visor body 16 by the fastening of a first screw 18A and a second screw 18B that serve as assembly members, or the like. A visor cover 20, which is shaped as a curved plate and serves as a covering member, is assembled to the vehicle front side of the visor body 16 via a reinforcement 24 that is described later. The outer periphery of the visor cover 20 is fit-together with the outer periphery of the visor body 16, and the visor cover 20 covers the vehicle front side of the visor body 16. An upper cover 20A at the upper side and a lower cover 20B at the lower side are provided at the visor cover 20. The visor cover 20 is structured due to the upper cover 20A and the lower cover 20B being combined.

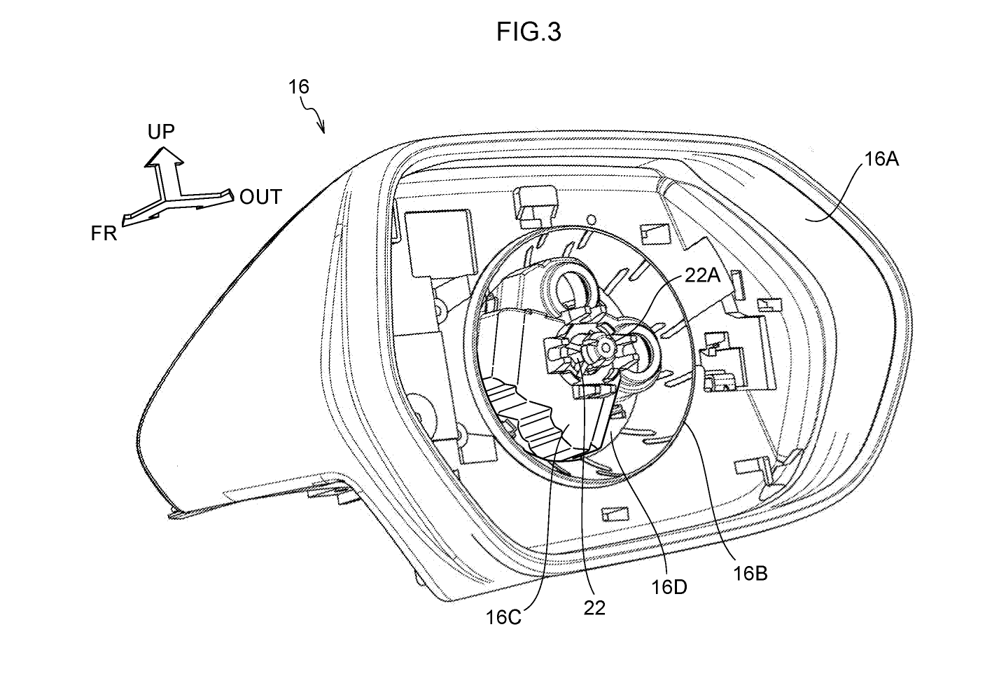

As shown in FIG. 1 through FIG. 3, an accommodating wall 16A, which is substantially shaped as a rectangular parallelepiped box and serves as an accommodating portion, is provided at the visor body 16. The interior of the accommodating wall 16A opens to the vehicle rear side.

A supporting wall 16B (case lower portion) that serves as a supporting portion is provided integrally with the vehicle front side wall (the bottom wall) of the accommodating wall 16A. The supporting wall 16B projects out toward the vehicle front side and the vehicle rear side of the vehicle front side wall of the accommodating wall 16A. The supporting wall 16B is substantially tubular, and the central axis of the supporting wall 16B is disposed parallel to the vehicle longitudinal direction. The supporting wall 16B is shaped as a spherical wall, and the inner diameter dimension of the supporting wall 16B gradually increases toward the vehicle rear side.

A covering wall 16C (case upper portion), which is shaped as a container and serves as a covering portion, is provided at the interior of the supporting wall 16B. The entire periphery at the vehicle front side end of the covering wall 16C is made integral with the entire periphery of the vehicle front side end of the supporting wall 16B. A connecting wall 16D that is flat-plate-shaped is provided integrally between the vehicle front side end of the covering wall 16C and the vehicle front side end of the supporting wall 16B. At the portion where the vehicle front side end of the covering wall 16C and the vehicle front side end of the supporting wall 16B are not directly made integral, the connecting wall 16D connects the vehicle front side end of the covering wall 16C and the vehicle front side end of the supporting wall 16B. The interior of the covering wall 16C opens toward the vehicle front side of the supporting wall 16B, and, due thereto, the interior of the covering wall 16C opens toward the vehicle front side of the accommodating wall 16A.

A predetermined number (four in the present embodiment) of limiting plates 16E, which are shaped as rectangular plates and serve as limiting portions, are provided integrally with the connecting wall 16D. The limiting plates 16E project out toward the vehicle front side from the connecting wall 16D. The predetermined number of limiting plates 16E are disposed at a substantially uniform interval in the peripheral direction of the supporting wall 16B, and the limiting plates 16E are disposed so as to intersect the radial direction of the supporting wall 16B.

A fit-together tube 16F, which is shaped as a cylindrical tube and serves as a fit-together portion, is provided integrally with the outer peripheral surface of the supporting wall 16B at the vehicle longitudinal direction intermediate portion. The fit-together tube 16F projects out toward the vehicle front side from the supporting wall 16B, and is disposed coaxially with the supporting wall 16B.

A holding tube 22, which is substantially shaped as a cylindrical tube and serves as a holding portion, is provided integrally with the vehicle rear side wall (the bottom wall) of the covering wall 16C. The holding tube 22 projects out toward the vehicle front side and the vehicle rear side of the vehicle rear side wall of the covering wall 16C, and is disposed coaxially with the supporting wall 16B. A holding sphere 22A that is substantially spherical is provided at the vehicle rear side end portion of the holding tube 22. The peripheral surfaces at the vehicle front side portion and the vehicle rear side portion of the holding sphere 22A are shaped as spherical surfaces, and the centers of those peripheral surfaces coincide with the center of the inner peripheral surface of the supporting wall 16B.

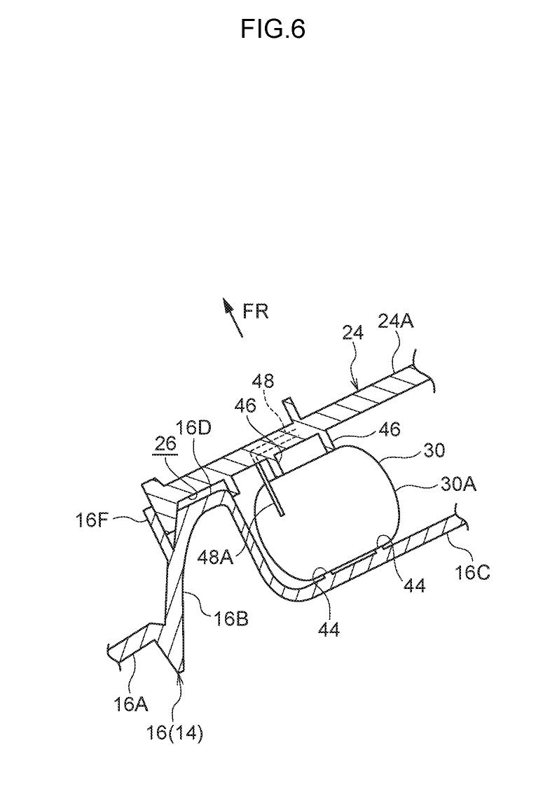

Two pairs of projecting ribs 44 (see FIG. 6), which are rectangular in cross-section and serve as additional stopping portions, are provided integrally with the vehicle rear side wall of the covering wall 16C. The projecting ribs 44 project out toward the vehicle front side, and are shaped as elongated flat plates. The vehicle longitudinal direction positions of the respective projecting ribs 44 coincide, and each pair of the projecting ribs 44 extend parallel to one another and are separated from one another in the transverse direction (the direction orthogonal to the vehicle longitudinal direction).

The reinforcement 24 (rigidity member), which is substantially made of resin and is shaped as an elongated plate and serves as a reinforcing body, is provided at the vehicle front sides of the visor body 16 and the rotating body 12B of the retracting mechanism 12. The vehicle transverse direction intermediate portion of the reinforcement 24 is fixed, together with the rotating body 12B, to the visor body 16 by the fastening of the first screw 18A and the second screw 18B.

A pair of assembly plates 24B, which are shaped as triangular plates and serve as assembly portions, are provided integrally with the vehicle transverse direction outer side portion of the reinforcement 24. The pair of assembly plates 24B respectively project out toward the upper side and the vehicle transverse direction outer side from the reinforcement 24. The vehicle transverse direction outer side portion of the reinforcement 24 is, at the pair of assembly plates 24B, fixed to the visor body 16 by the fastening of a third screw 18C and a fourth screw 18D that serve as assembly members, respectively. The vehicle transverse direction inner side end portion of the reinforcement 24 is fixed to the rotating body 12B by the fastening of a fifth screw 18E that serves as an assembly member.

The rigidity of the reinforcement 24 is made to be high as compared with the visor body 16, and the reinforcement 24 reinforces the visor body 16 and the rotating body 12B. Further, the visor cover 20 (the lower cover 20B) of the visor 14 is fixed to the reinforcement 24 by the fastening of a sixth screw 18F that serves as a fixing member. Due thereto, the visor cover 20 is assembled to the visor body 16 via the reinforcement 24 as described above.

A bottom wall portion 24A, which is disc-shaped and serves as a closing-off portion, is provided at the vehicle transverse direction outer side portion of the reinforcement 24. A concave portion 26, which is rectangular in cross-section and serves as an insertion portion, is formed at the outer peripheral portion of the vehicle rear side surface of the bottom wall portion 24A, at the entire periphery thereof. The bottom wall portion 24A is fit-together within the fit-together tube 16F of the visor body 16, and the vehicle front side end of the supporting wall 16B of the visor body 16 is inserted into the concave portion 26, and the outer peripheral surface of the supporting wall 16B is fit-together with the outer peripheral surface of the concave portion 26. Due thereto, the bottom wall portion 24A covers and closes-off the vehicle front sides of the supporting wall 16B and the covering wall 16C of the visor body 16.

A predetermined number (four in the present embodiment) of limiting holes 24C, which are rectangular and serve as limited portions, are formed in the bottom wall portion 24A so as to pass therethrough. The predetermined number of limiting holes 24C are disposed at a substantially uniform interval in the peripheral direction of the bottom wall portion 24A, and are respectively disposed so as to intersect the radial direction of the bottom wall portion 24A. The limiting plates 16E of the visor body 16 are inserted into (fit-together with) the limiting holes 24C. Due thereto, movement of the bottom wall portion 24A in the peripheral direction and the radial direction with respect to the visor body 16 is limited.

A fit-in pillar 24D, which is substantially solid cylindrical and serves as a fit-in portion, is provided integrally with the central portion of the bottom wall portion 24A. The fit-in pillar 24D projects out toward the vehicle rear side from the bottom wall portion 24A, and is disposed coaxially with the bottom wall portion 24A. The diameter of the distal end portion of the fit-in pillar 24D is narrowed, and the distal end portion of the fit-in pillar 24D is fit into the holding tube 22 of the visor body 16 from the vehicle front side.

A supporting tube 24E that is shaped as a cylindrical tube is provided integrally with the upper portion and the vehicle transverse direction outer side portion of the bottom wall portion 24A, at the bottom wall portion 24A radial direction inner side of the assembly plates 24B. The supporting tube 24E projects out toward the vehicle rear side from the bottom wall portion 24A, and the central axis of the supporting tube 24E is disposed parallel to the central axis of the bottom wall portion 24A.

Two pairs of holding ribs 46 (see FIG. 6), which are rectangular in cross-section and serve as stopping portions, are provided integrally with the bottom wall portion 24A. The holding ribs 46 project out toward the vehicle rear side, and are formed in the shapes of elongated flat plates. The vehicle longitudinal direction positions of the respective holding ribs 46 coincide, and each of the pairs of the holding ribs 46 respectively extend parallel to one another, and are disposed apart from one another in the wall thickness direction (the direction orthogonal to the vehicle longitudinal direction). Further, the respective holding ribs 46 face, in the vehicle longitudinal direction, the respective projecting ribs 44 of the covering wall 16C of the visor body 16.

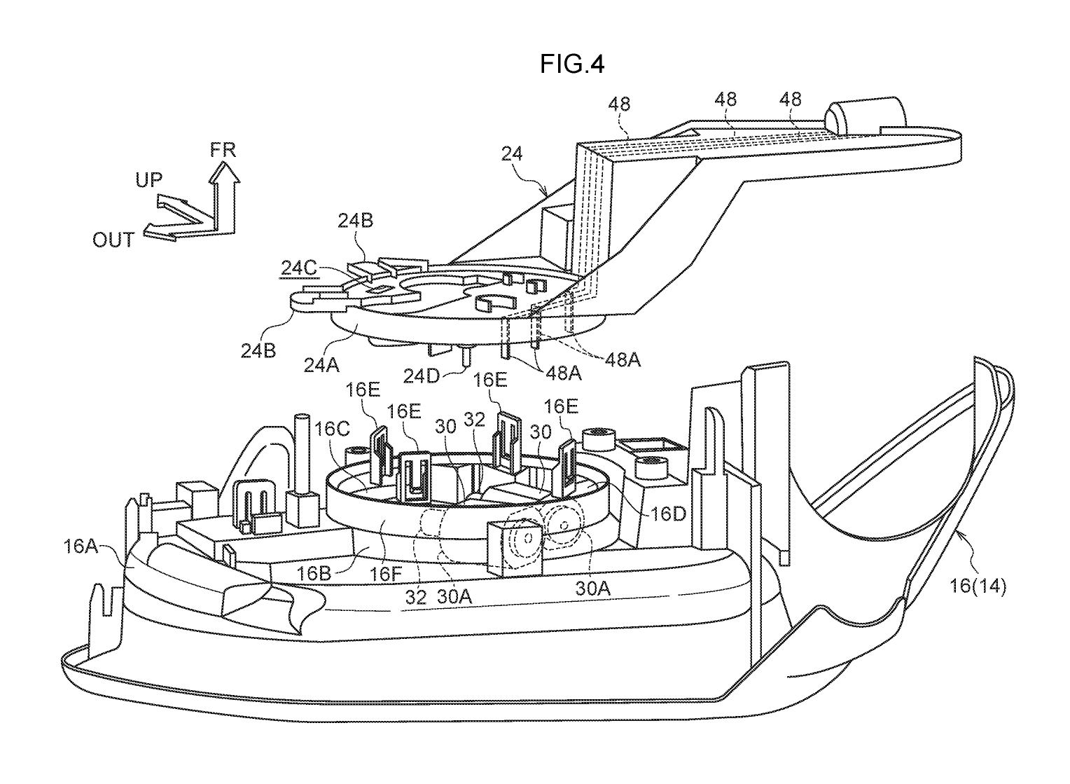

Plural wires 48 (see FIG. 4), which are shaped as elongated plates, are provided within the reinforcement 24 by insert molding. The proximal end sides of the plural wires 48 are electrically connected to the control device. Two pairs of terminals 48A (see FIG. 4), which are shaped as elongated plates, are provided at the reinforcement 24 by insert molding. The proximal ends of the terminals 48A are made integral with the distal end sides of the wires 48, and the proximal end portions of the terminals 48A are fixed to the reinforcement 24 interior, and the terminals 48A extend out from the reinforcement 24 toward the vehicle rear side. The vehicle longitudinal direction positions of the respective terminals 48A coincide, and each of the pairs of terminals 48A respectively are disposed parallel to one another, and face one another in a state of being apart from one another in the wall thickness direction (the direction orthogonal to the vehicle longitudinal direction).

A mirror surface adjusting mechanism 28 that serves as a tilting mechanism is held between the covering wall 16C of the visor body 16 and the bottom wall portion 24A of the reinforcement 24.

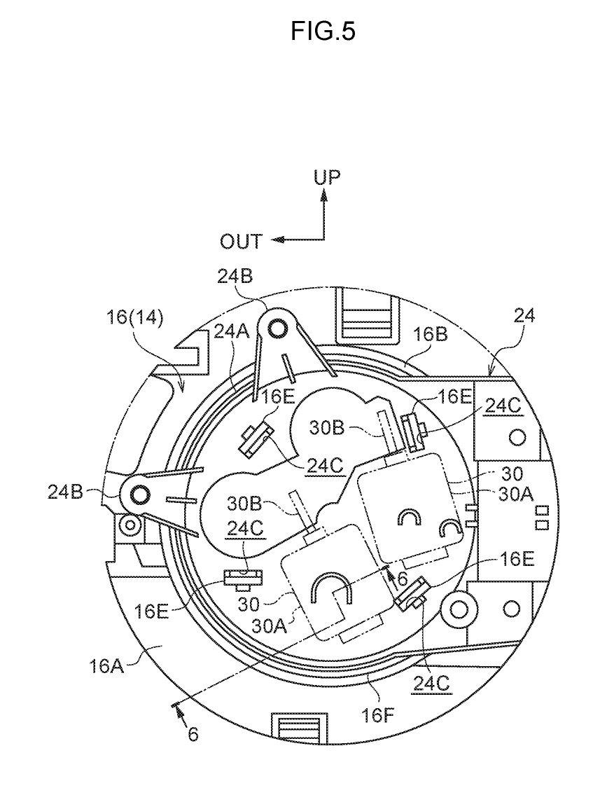

A pair of motors 30 (see FIG. 4 through FIG. 6) that serve as a driving mechanism are provided at the mirror surface adjusting mechanism 28. A main body portion 30A that is substantially shaped as an oval pillar is provided at the motor 30, and an output shaft 30B that is substantially shaped as a cylindrical pillar is provided coaxially with the main body portion 30A.

The vehicle front side surface and the vehicle rear side surface of the main body portion 30A are rectangular, flat surfaces, and are disposed orthogonal to the vehicle longitudinal direction. The vehicle front side surface and the vehicle rear side surface of the main body portion 30A face one another in the vehicle longitudinal direction. The distal end surfaces (the vehicle front side surfaces) of the projecting ribs 44 of the covering wall 16C planarly-contact, along the length direction, the transverse direction both end portions of the vehicle rear side surface of the main body portion 30A. The distal end surfaces (the vehicle rear side surfaces) of the holding ribs 46 of the bottom wall portion 24A planarly-contact, along the length direction, the transverse direction both end portions of the vehicle front side surface of the main body portion 30A. The pair of projecting ribs 44 and the pair of holding ribs 46 nip and hold the main body portion 30A in the vehicle longitudinal direction, and stop the rotation of the main body portion 30A around the output shaft 30B. Further, the length directions of the pair of projecting ribs 44 and the pair of holding ribs 46 are disposed parallel to the axial direction of the output shaft 30B.

The pair of terminals 48A of the reinforcement 24 are inserted into the proximal end portion (the lower side end portion) of the main body portion 30A, and the pair of terminals 48A stop rotation of the main body portion 30A around the output shaft 30B. The main body portion 30A is electrically connected to the control device via the pair of terminals 48A and the wires 48 of the reinforcement 24. Due to control of the control device, electric power is supplied from the terminals 48A to the main body portion 30A, and the motor 30 is driven. Due thereto, the output shaft 30B is rotated, and the mirror surface adjusting mechanism 28 is electrically operated.

The output shaft 30B extends from the distal end (the upper side end) of the main body portion 30A. A worm 32 that serves as an output member is fixed coaxially to the output shaft 30B.

A pair of wheel drives 34, which are substantially cylindrical tube shaped and are made of resin and serve as transmitting members, are provided at the mirror surface adjusting mechanism 28. The wheel drives 34 are nipped between the covering wall 16C and the bottom wall portion 24A in a state of the vehicle front side portions of the wheel drives 34 being fit-into the supporting tube 24E of the bottom wall portion 24A, and are held so as to rotate freely around the axes thereof.

A worm wheel 34A is formed coaxially at the outer peripheral portion of the wheel drive 34, at the axial direction (vehicle longitudinal direction) intermediate portion thereof. The worm wheel 34A meshes-together with (is engaged with) the worm 32 of the motor 30. Therefore, due to the motor 30 being driven and the worm 32 being rotated integrally with the output shaft 30B of the motor 30, the worm wheel 34A is rotated, and the wheel drive 34 is rotated.

A predetermined number (four in the present embodiment) of meshing claws 34B that serve as engaging portions are formed at the inner peripheral portion of the wheel drive 34 at the vehicle rear side of the worm wheel 34A. The predetermined number of meshing claws 34B are disposed at a uniform interval in the peripheral direction of the wheel drive 34. The meshing claws 34B extend out toward the vehicle rear side, and are elastic. The distal ends (the vehicle rear side ends) of the meshing claws 34B project out toward the radial direction inner side of the wheel drive 34.

Rod drives 36, which are substantially shaped as solid cylinders and serve as moving members, are coaxially inserted within the wheel drives 34. The rod drives 36 project out toward the vehicle rear side from the covering wall 16C. The one rod drive 36 is disposed above (or may be disposed beneath) the central axis of the supporting wall 16B of the visor body 16, and the other rod drive 36 is disposed at the vehicle transverse direction outer side (or may be disposed at the vehicle transverse direction inner side) of the central axis of the supporting wall 16B.

The portions, which are other than the distal end portions (the vehicle rear side end portions), of the rod drives 36 are made to be screws 36A. The distal ends of the meshing claws 34B of the wheel drives 34 are meshed-together with (engaged with) the screws 36A. Further, the distal end portions of the rod drives 36 are formed in substantially spherical shapes.

A mirror body 38 that serves as a viewing mechanism is accommodated within the accommodating wall 16A of the visor body 16. The entire periphery of and the vehicle front side of the mirror body 38 are covered by the accommodating wall 16A.

A mirror 40, which is substantially shaped as a rectangular plate and serves as a viewing portion, is provided at the vehicle rear side portion of the mirror body 38. The obverse of the mirror 40 is exposed at the vehicle rear side of the visor body 16. A mirror surface 40A (the obverse of the reflecting layer at the reverse side) of the mirror 40 faces the vehicle rear side, and viewing of the vehicle rear side by an occupant of the vehicle (the driver in particular) is assisted by the mirror 40.

A mirror holder 42, which is substantially shaped as a rectangular plate and is made of resin and serves as a sliding body, is provided at the vehicle front side portion of the mirror body 38. The entire periphery of the mirror 40 is fixed to (held at) the entire periphery of the mirror holder 42, and the mirror holder 42 covers the vehicle front side (the reverse side) of the mirror 40.

A mounting wall 42A, which is substantially tubular and serves as a mounting portion, is formed at the mirror holder 42 at the vehicle front side of the central position (the center of gravity position) of the mirror 40. The mounting wall 42A is disposed coaxially with the supporting wall 16B of the visor body 16. The mounting wall 42A is substantially shaped as a spherical wall, and the inner diameter dimension of the mounting wall 42A gradually becomes larger toward the vehicle rear side. The holding sphere 22A of the holding tube 22 of the visor body 16 is fit into the mounting wall 42A. Due thereto, the mirror body 38 is held at the holding tube 22 so as to be able to tilt and so as to be able to slide.

A sliding wall 42B, which is substantially tubular and serves as a sliding portion, is provided integrally with the vehicle front side of the mirror holder 42. The sliding wall 42B is disposed coaxially with the supporting wall 16B of the visor body 16. The sliding wall 42B is shaped as a spherical wall, and the outer diameter dimension of the sliding wall 42B gradually becomes larger toward the vehicle rear side. The outer peripheral surface of the sliding wall 42B abuts the inner peripheral surface of the supporting wall 16B, and the sliding wall 42B is supported at the supporting wall 16B so as to be able to tilt and so as to be able to slide.

A pair of rotating walls 42C, which are substantially tubular and serve as rotating portions, are formed at the mirror holder 42 at the radial direction inner side of the sliding wall 42B. One of the rotating walls 42C is disposed at the upper side (or may be disposed at the lower side) of the central axis of the supporting wall 16B of the visor body 16. The other rotating wall 42C is disposed at the vehicle transverse direction outer side (or may be disposed at the vehicle transverse direction inner side) of the central axis of the supporting wall 16B. The central axes of the rotating walls 42C are disposed parallel to the central axis of the supporting wall 16B of the visor body 16, and the rotating walls 42C are substantially shaped as spherical walls. The inner diameter dimensions of the rotating walls 42C gradually become larger from the vehicle longitudinal direction both end sides toward the vehicle longitudinal direction central sides thereof.

The distal end portions of the rod drives 36 at the mirror surface adjusting mechanism 28 are fit into and held at the interiors of the rotating walls 42C. Rotation of the rotating walls 42C with respect to the distal end portions of the rod drives 36 is permitted, and rotation around the axes of the rod drives 36 is restricted. Therefore, as described above, at the mirror surface adjusting mechanism 28, due to the wheel drives 34 (including the meshing claws 34B) being rotated, the meshed positions of the distal ends of the meshing claws 34B with the screws 36A of the rod drives 36 are displaced, and the rod drives 36 are moved (slid) in the vehicle longitudinal direction (the axial direction).

Operation of the present embodiment is described next.

In the door mirror device 10 for a vehicle of the above-described structure, due to electrical operation of the mirror surface adjusting mechanism 28, the motors 30 are driven, and the worms 32 are rotated integrally with the output shafts 30B of the motors 30, and, due thereto, the wheel drives 34 are rotated, and the rod drives 36 are moved in the vehicle longitudinal direction. Therefore, the mirror body 38 (the mirror 40 and the mirror holder 42) is tilted by the rod drives 36 in at least one of the vertical direction or the vehicle transverse direction, and the angle of the mirror surface 40A of the mirror 40 (the direction of viewing by the vehicle occupant whom the mirror 40 assists) is adjusted in at least one of the vertical direction or the vehicle transverse direction.

By the way, the covering wall 16C of the visor body 16 covers the vehicle rear sides (the mirror body 38 sides) of the motors 30, and the bottom wall portion 24A of the reinforcement 24 is disposed at the vehicle front sides of the motors 30 (the sides opposite from the mirror body 38), and the reinforcement 24 reinforces the visor body 16. Moreover, the terminals 48A of the reinforcement 24 supply electric power to the main body portions 30A of the motors 30.

Here, the holding ribs 46 of the bottom wall portion 24A stop rotation of the main body portions 30A around the output shafts 30B. Therefore, the main body portions 30A being rotated around the output shafts 30B by the reaction forces that arise due to the motors 30 being driven (the reaction forces that arise due to the output shafts 30B and the worms 32 rotating the wheel drives 34) can be suppressed, and the main body portions 30A rattling between the covering wall 16C and the bottom wall portion 24A can be suppressed.

Moreover, the projecting ribs 44 of the covering wall 16C stop rotation of the main body portions 30A around the output shafts 30B. Therefore, the main body portions 30A being rotated around the output shafts 30B by the reaction forces that arise due to the motors 30 being driven can be suppressed even more.

Further, the holding ribs 46 and the projecting ribs 44 are disposed parallel to the output shafts 30B. Therefore, the holding ribs 46 and the projecting ribs 44 can effectively stop rotation of the main body portions 30A around the output shafts 30B, and the main body portions 30A being rotated around the output shafts 30B by the reaction forces that arise due to the motors 30 being driven can be suppressed effectively.

Moreover, the pair of holding ribs 46 stop rotation of the main body portion 30A around the output shaft 30B, and the pair of projecting ribs 44 stop rotation of the main body portion 30A around the output shaft 30B. Therefore, the pair of holding ribs 46 and the pair of projecting ribs 44 can more effectively stop rotation of the main body portion 30A around the output shaft 30B, and the main body portion 30A being rotated around the output shaft 30B by the reaction force that arises due to the motor 30 being driven can be suppressed more effectively.

Moreover, the pair of terminals 48A of the reinforcement 24 are inserted into the main body portion 30A, and stop rotation of the main body portion 30A around the output shaft 30B. Therefore, the main body portion 30A being rotated around the output shaft 30B by the reaction force that arises due to the motor 30 being driven can be suppressed more effectively.

Further, the terminals 48A are provided integrally with the reinforcement 24. Therefore, the need to provide, separately from the reinforcement 24, parts at which the terminals 48A are provided (e.g., connectors) can be eliminated. The number of parts can be reduced, the number of assembly processes of the door mirror device 10 for a vehicle can be reduced, and costs can be reduced.

Moreover, the wires 48 are provided integrally with the reinforcement 24. Therefore, there is no need to route the wires 48, which are separate from the reinforcement 24, to the main body portions 30A of the motors 30. The number of assembly processes of the door mirror device 10 for a vehicle can be reduced, and the occurrence of abnormal noise (e.g., a striking sound) due to the wires 48 and disconnecting of the wires 48 can be suppressed.

Note that, in the present embodiment, the covering wall 16C is provided at the visor body 16. However, the covering wall 16C may be made to be a body that is separate from the visor body 16.

Further, in the present embodiment, at the reinforcement 24 (the bottom wall portion 24A), one pair of the holding ribs 46 is provided for one of the main body portion 30A of the motors 30. However, at the reinforcement 24 (the bottom wall portion 24A), one or three or more of the holding ribs 46 may be provided for one of the main body portion 30A of the motors 30.

Moreover, in the present embodiment, at the visor body 16 (the covering wall 16C), one pair of the projecting ribs 44 is provided for one of the main body portion 30A of the motors 30. However, at the visor body 16 (the covering wall 16C), one or three or more of the projecting ribs 44 may be provided for one of the main body portion 30A of the motors 30.

Further, in the present embodiment, the mirror body 38 is made to be the viewing mechanism. However, a camera, which assists viewing by the vehicle occupant by capturing images, may be made to be the viewing mechanism.

Moreover, in the present embodiment, the door mirror device 10 for a vehicle (the viewing device for a vehicle) is set at the outer side of a door of the vehicle. However, the viewing device for a vehicle may be set at another position of the vehicle.

The disclosure of Japanese Patent Application No. 2016-183428 that was filed on Sep. 20, 2016 is, in its entirety, incorporated by reference into the present specification.

### EXPLANATION OF REFERENCE NUMERALS

10 door mirror device for a vehicle (viewing device for a vehicle)
16 visor body (covering body)
24 reinforcement (reinforcing body)
28 mirror surface adjusting mechanism (tilting mechanism)
30 motor
30A main body portion
30B output shaft
38 mirror body (viewing mechanism)
46 holding rib (stopping portion)
48A terminal

1. A viewing device for a vehicle, the viewing device comprising:
a viewing mechanism that assists viewing by an occupant of the vehicle;
a tilting mechanism at which a motor, having an output shaft extending out from a main body portion, is provided, the viewing mechanism being tilted due to the motor being driven and the output shaft being rotated;
a covering body that covers a viewing mechanism side of the motor;
a reinforcing body that is disposed at a side, which is opposite from the viewing mechanism, of the motor, and that reinforces the covering body; and
a stopping portion that is provided so as to project out from the reinforcing body, and that stops rotation of the main body portion around the output shaft.

2. The viewing device for a vehicle of claim 1, wherein the stopping portion is extended along the output shaft.

3. The viewing device for a vehicle of claim 1, wherein the stopping portion is provided at a plurality of positions around the output shaft.

4. The viewing device for a vehicle of any one of claim 1, comprising a terminal that is provided integrally with the reinforcing body, that is inserted into the main body portion, and that supplies electric power.

5. The viewing device for a vehicle of claim 1, comprising an additional stopping portion that is provided so as to project out at the covering body, and that stops rotation of the main body portion around the output shaft.

6. The viewing device for a vehicle of claim 5, wherein the additional stopping portion is extended along the output shaft.

7. The viewing device for a vehicle of claim 5, wherein the additional stopping portion is provided at a plurality of positions around the output shaft.

8. The viewing device for a vehicle of claim 5, wherein the additional stopping portion faces the stopping portion.
